(19) United States
(12) Patent Application Publication
(10) Pub. No.: US 2005/0204072 A1
(43) Pub. Date: Sep. 15, 2005

(54) Communication system, communication apparatus, communication method, and computer program thereof

(76) Inventor: Kazuhiro Nakagawa, Tokyo (JP)

Correspondence Address: William S. Frommer, Esq.;FROMMER LAWRENCE & HAUG LLP, 745 Fifth Avenue, New York, NY, 10151, US

(21) Appl. No.: 11/069,725

(22) Filed: Mar. 1, 2005

(30) Foreign Application Priority Data
Mar. 2, 2004 (JP) 2004-057771

(51) Int. Cl. G06F 13/10

(52) U.S. Cl. 710/8

(57) ABSTRACT

The present invention provides a communication system, a communication apparatus, a communication method, and a computer program thereof, which may improve communication performance, such as power consumption of communication process and communication speed. Communication apparatuses 101 and 102 are in compliance with USB OTG, and the communication apparatus 101 starts as a host device and the communication apparatus 102 starts as a peripheral device. In an enumeration process, the communication apparatus 101 acquires information, as a descriptor, on power consumption when the communication apparatus 102 operates as the host device and the peripheral device, from the communication apparatus 102. Based on this acquired descriptor and a descriptor including similar information on its own power consumption, the communication apparatus 101 determines whether the power consumption decreases by switching the peripheral and the host. As a result of the determination, when it is determined that the power consumption decreases, the host and the peripheral are switched according to a communication protocol of OTG.

### CROSS REFERENCE TO RELATED APPLICATONS

The present document is based on Japanese Priority Document JP2004-057771, filed to the Japanese Patent Office on Mar. 2, 2004, the contents of which being incorporated herein by reference.

### BACKGROUND OF THE INVENTION

1. Field of the Invention

The present invention relates to a communication system, a communication apparatus, a communication method, and a computer program for a computer for communication control, using a bus, such as USB.

2. Related Art

USB (universal serial bus) is generally known as a main standard for high-speed serial communications where a personal computer is connected to its peripheral devices. A USB communication system has a structure where a plurality of devices are connected via a common serial communications bus, and one of the plurality of devices functions as a so-called host and others function as a so-called peripheral.

A host device has the role of a controller for controlling general transmission of the data in a bus, and a personal computer usually becomes the host device. The host device performs a process of detecting a peripheral device newly connected to the bus, a process of managing a data flow on a bus, etc.

On the other hand, the peripheral device communicates under the control of the host device. In other words, the communications is carried out in such a way that a request is sent from the host device to the peripheral device, and the peripheral device returns a response to this request. Both an operation in which the peripheral device notifies its own information to the host device, and an operation in which data communications with the host device is performed are carried out as operations in response to the request from the host device.

In many cases, it is determined whether a device for communicating by means of USB has a host function or a peripheral function at time of designing the device. Therefore, a normal device in compliance with USB cannot change this function according to the case of usage.

Conversely, in a complementary standard of USB2.0 called USB On-The-Go (hereafter referred to as OTG), it becomes possible to switch between the peripheral function and the host function. Thus, it becomes possible to add the host function to a device, such as a digital camera which does not usually have the host function, and to directly transmit data not via a personal computer among these devices.

In OTG, a dual-role device is defined as a device which has both the host function and the peripheral function. The dual-role device determines a function of an initial status according to a type of a plug of a USB cable to be connected. In other words, when connected with a plug called Mini-A of the USB cable, it turns into a host device in an initial status. When connected with a plug called Mini-B of the USB cable, it turns to a peripheral device in an initial status. The device connected to the Mini-A plug is called Device A, and the device connected to the Mini-B plug is called Device B.

Further, in addition to the communication protocol of USB2.0, in OTG, the communication protocol called SRP (session request protocol) and HNP (host negotiation protocol) are prepared.

The “A” device defined by the OTG is allowed to stop electric current from being supplied to a bus when not in communications. SRP is a communication protocol for urging re-start of the electric current from Device B to Device A when the electric current supply is stopped. Thus, since the electric current supply to the bus can be stopped until it is requested by Device B, power consumption when not in communications can be reduced.

HNP is a communication protocol for switching between the host function and the peripheral function without switching plugs, when one of two dual-role devices operates as the host device and the other operates as the peripheral device according to the type of each connecting plug. Thus, since the time of switching the plugs can be saved, user-friendliness can be improved.

Japanese Laid-open Patent Application No. 2003-316728 is related with an apparatus which performs data transfer in compliance with the OTG.

### SUMMARY OF THE INVENTION

By the way, it is expected that USB communication apparatuses in compliance with this OTG would mainly be installed in mobile devices, such as a digital camera and a PDA (personal digital assistant), etc. Since the mobile device is generally driven by a battery power supply, it has an important problem in reducing power consumption. Therefore, electric power consumed in the USB communication device is also required to be reduced as much as possible.

Further, in recent years, since data of massive volume, such as a video image, are often handled in the mobile devices, a communication apparatus mounted in such a device needs a higher communication speed.

The present invention has been conceived in view of the above situation, and a communication system, a communication apparatus, a communication method, and a computer program for communication control are provided, which carry out communications via a bus, and which may improve communication performance, such as power consumption of communication processing, and communication speed, when performing communications which may switch, according to a predetermined communication protocol, between a host function for controlling transmission of data over a bus, and a peripheral function for communicating under the control of a communication counterpart which has the host function.

A communication system according to a preferred embodiment of the present invention has two communication apparatuses which communicate via a bus, wherein, when one communication apparatus operates in a first mode of controlling data transmission over this bus, the other communication apparatus operates in a second mode of performing communications under the control of the one communication apparatus, and modes of operation of the two communication apparatuses may be switched according to a predetermined communication protocol.

In this preferred embodiment of the present invention, the communication apparatus includes:
a storage unit for storing information related to a predetermined communication performance when the communication apparatus itself operates in each of the first mode and the second mode; and
a control unit in which, when starting with the above-mentioned second mode, information on the communication performance stored in the storage unit is outputted to the bus, under the control of a communication counterpart which operates in the first mode of operation; when starting with the first mode, information on the communication performance is acquired via the bus from the communication counterpart which operates in the second mode of operation; based on the acquired information on the communication performance of the communication counterpart and the information on the communication performance of the communication apparatus itself, the information being stored in the storage unit, it is determined whether or not the communication performance is improved when the modes of operation are switched; when it is determined that the communication performance is improved, the modes of operation are switched.

Preferably, the above-mentioned storage unit stores either the information on the communication speed or the information on the power consumption or both as the information related to the predetermined communication performance.

According to a preferred embodiment of the invention, the communication apparatus started with the first mode controls and outputs, to the bus, the information on the communication performance, which is stored in the storage unit of the communication apparatus started with the second mode, whereby the information on the communication performance of the communication apparatus started with the second mode is acquired by the communication apparatus started with the first mode. In the communication apparatus started with the first mode, based on the acquired information on the communication performance of the communication counterpart, and the information on the communication performance itself stored in the storage unit, it is determined whether or not the communication performance is improved when the modes of operation are switched. For example, it is determined whether or not the communication speed is increased, or whether or not the power consumption needed for a communication process decreases, etc. As a result of this determination, when it is determined that the communication performance is improved, the communication apparatus started with the first mode performs the switching of the modes of operation, according to the predetermined communication protocol.

A communication apparatus according to another preferred embodiment of the invention is a communication apparatus in which a mode of operation when performing communications via a bus may be switched between a first mode of controlling data transmission over the bus, and a second mode of performing communications under the control of a communication counterpart which operates in the first mode.

The communication apparatus of this preferred embodiment of the invention includes:
a storage unit for storing information related to a predetermined communication performance when the communication apparatus itself operates in each of the first mode and the second mode; and
a control unit in which when starting with the first mode, information on the communication performance of the communication counterpart in the first mode and the second mode is acquired from the communication counterpart which operates in the second mode of operation; based on the acquired information on the communication performance of the communication counterpart, and information on the communication performance of the communication apparatus itself, the information being stored in the storage unit, it is determined whether or not the communication performance is improved, when the mode of operation is switched to that of the communication counterpart; when it is determined that the communication performance is improved, the modes of operation are switched according to a predetermined communication protocol.

Preferably, the above-mentioned storage unit stores either or both of the information on the communication speed and the information on the power consumption as the information related to the predetermined communication performance.

According to the second preferred embodiment of the invention, when starting with the above-mentioned first mode, the information on the communication performance of the communication counterpart in the above-mentioned first mode and the second mode is acquired from the communication counterpart which operates in the second mode under the control of the control unit. Then, in the control unit, based on the acquired information on the communication performance of the communication counterpart and the information on the communication performance of the communication apparatus itself stored in the storage unit, it is determined whether or not the communication performance is improved when the modes of operation are switched. For example, it is determined whether or not the communication speed is increased, or whether or not the power consumption needed for a communication process decreases, etc. As a result of this determination, when it is determined that the communication performance is improved, the modes of operation are switched under the control of the control unit, according to the predetermined communication protocol.

A communication method according to another preferred embodiment of the invention is a communication method in which one of two communication apparatuses which communicate via a bus operates in a first mode of controlling data transmission over the bus, the other communication apparatus operates in a second mode of performing communications under the control of the one communication apparatus, and the modes of operation of the two communication apparatuses may be switched according to a predetermined communication protocol.

The communication method of this preferred embodiment of the invention includes:
a first step of starting a first communication apparatus with the first mode, and starting a second communication apparatus with the second mode;
a second step of transmitting information related to a predetermined communication performance when the second communication apparatus operates in each of the first mode and the second mode, from the second communication apparatus to the first communication apparatus via the bus;
a third step of causing the first communication apparatus to determine whether or not the communication performance is improved when the modes of operation are switched, based on the information on the communication performance, the information being acquired from the second communication apparatus, and the information on the communication performance of its own in the first mode and the second mode; and
a fourth step of causing the first communication apparatus to switch the modes of operation when it is determined that the communication performance is improved in the third step.

According to the third preferred embodiment of the invention, in the first step, the first communication apparatus starts with the first mode, and the second communication apparatus starts with the second mode. In the second step, the information on the predetermined communication performance of the second communication apparatus in the first mode and the second mode is transmitted from the second communication apparatus to the first communication apparatus via the bus. In the third step, in the first communication apparatus, based on the information on the communication performance acquired from the second communication apparatus and the information on the communication performance of its own in the first mode and the second mode, it is determined whether or not the communication performance is improved when the modes of operation are switched. In the third step, when it is determined that the communication performance is improved; the switching of the modes of operation is performed by the first communication apparatus in the fourth step.

A computer program according to another preferred embodiment of the invention is a computer program for a computer for controlling a communication apparatus in which a mode of operation at time of performing communications via a bus may be switched between a first mode of controlling data transmission over the bus, and a second mode of performing communications under the control of a communication counterpart which operates in the first mode.

The computer program of this preferred embodiment of the invention includes: a first step of acquiring information on a predetermined communication performance of the communication counterpart in the first mode and the second mode, from the communication counterpart which operates in the second mode of operation, when starting with the first mode; a second step of determining whether or not the communication performance is improved when the mode of operation is switched to the communication counterpart, based on the information on the communication performance of the communication counterpart, the information being acquired in the first step, and the information on the communication performance of the communication apparatus itself in the first mode and the second mode; and a third step of switching the modes of operation according to a predetermined communication protocol, when it is determined that the communication performance is improved in the second step.

According to the fourth preferred embodiment of the invention, when starting with the first mode, in the first step, the information on the predetermined communication performance of the communication counterpart in the first mode and the second mode is acquired from the communication counterpart which operates in the second mode of operation. In the second step, based on the information on the communication performance of the communication counterpart acquired in the first step and the information on the communication performance of the communication apparatus itself in the first mode and the second mode, it is determined whether or not the communication performance is improved when the mode of operation is switched to that of the communication counterpart. In the second step, when it is determined that the communication performance is improved, the switching of the modes of operation is performed in the third step, according to a predetermined communication protocol.

According to a preferred embodiment of the present invention, based on the information on the communication performance, the operation mode at time of performing communications via the bus may suitably be switched from the first mode of controlling the data transmission over the bus, to the second mode of performing communications under the control of the communication counterpart which operates in the first mode, thereby improving the communication performance.

### BRIEF DESCRIPTION OF THE DRAWINGS

The above and other objects, features and advantages of the present invention will become more apparent from the following description of the presently preferred exemplary embodiments of the invention taken in conjunction with the accompanying drawings, in which:

FIG. 1 is a diagram showing an example of a structure of a communication system in accordance with a preferred embodiment of the present invention;

FIG. 2 is a diagram showing an example of a structure of a communication processing unit in a communication apparatus as shown in FIG. 1;

FIG. 3 is a diagram for explaining an operation of switching modes of operation in the communication processing unit;

FIG. 4 is a flow chart showing an example of an operation of the communication apparatus, as shown in FIG. 2, which operates as Device A;

FIG. 5 is a chart showing an example of a data structure of a descriptor in accordance with the first preferred embodiment, including information on power consumption;

FIG. 6 is a first chart showing a particular example of the descriptor as shown in FIG. 5;

FIG. 7 is a chart for explaining an example of a communication procedure between Device A and Device B in the communication system in accordance with the first preferred embodiment;

FIG. 8 is a second chart showing a particular example of the descriptor as shown in FIG. 5;

FIG. 9 is a third chart showing a particular example of the descriptor as shown in FIG. 5;

FIG. 10 is a chart showing an example of a data structure of the descriptor in accordance with the first preferred embodiment, including information on power consumption and communication speed;

FIG. 11 is a diagram showing an example of a structure of the communication apparatus in accordance with the second preferred embodiment;

FIG. 12 is a flow chart showing an example of an operation of the communication apparatus as shown in FIG. 11 which operates as Device A;

FIG. 13 is a chart showing an example of a data structure of the descriptor in accordance with the second preferred embodiment, including information on a class available at time of the first mode, and its communication speed;

FIG. 14 is a chart showing a particular example of the descriptor as shown in FIG. 13; and

FIG. 15 is a picture for explaining an example of a communication procedure between Device A and Device B in the communication system in accordance with the second preferred embodiment.

### DESCRIPTION OF THE PREFERRED EMBODIMENTS

Preferred embodiments of the present invention will be described below applied to communication apparatuses in compliance with the OTG (USB On-The-Go).

### First Preferred Embodiment

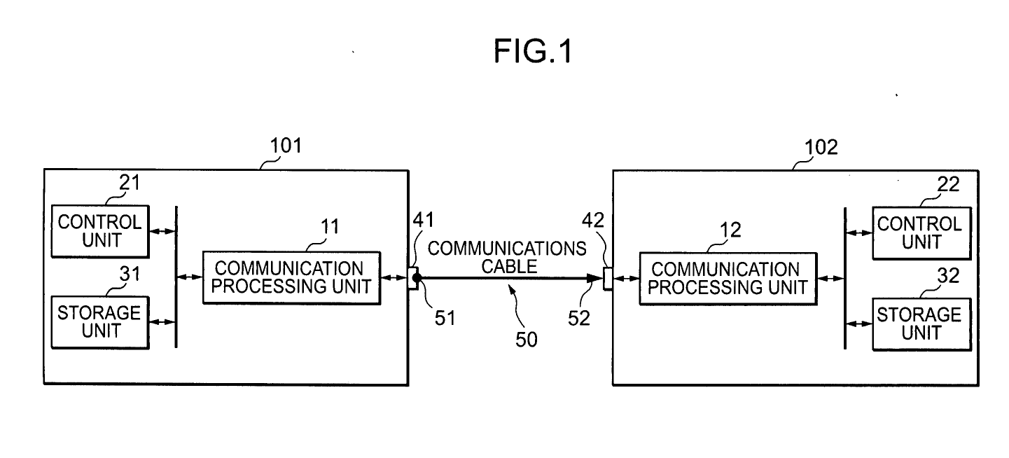

FIG. 1 is a diagram showing an example of a structure of a communication system in accordance with a preferred embodiment of the present invention.

The communication system as shown in FIG. 1 has a communications cable 50 and communication apparatuses 101 and 102.

The communication apparatus 101 has a communication processing unit 11, a control unit 21, a storage unit 31, and a receptacle terminal 41.

The communication apparatus 102 has a communication processing unit 12, a control unit 22, a storage unit 32, and a receptacle terminal 42.

In addition, the communication apparatuses 101, 102 are preferred embodiments of the communication apparatus of the present invention.

The control units 21 and 22 are preferred embodiments of the control unit of the present invention.

The storage units 31 and 32 are preferred embodiments of the storage unit of the present invention.

[Communications Cable 50]

The communications cable 50 is a communications cable in compliance with OTG, has a Mini-A plug terminal 51 at one end, and has a Mini-B plug terminal 52 at the other end.

[Communication Apparatuses 101, 102]

The communication apparatuses 101 and 102 are dual-role devices defined in OTG, and become Device A when connected with the Mini-A plug terminal 51 or Device B when connected with the Mini-B plug terminal 52.

In the example of FIG. 1, the communication apparatus 101 is connected to the Mini-A plug terminal 51, and the communication apparatus 102 is connected to the Mini-B plug terminal 52. Therefore, in this case, the communication apparatus 101 becomes Device A and the communication apparatus 102 becomes Device B. In other words, the communication apparatus 101 operates as the host device at time of starting, and the communication apparatus 102 operates as the peripheral device at time of starting.

In addition, in the present specification, a mode of operation when operating as the host device is referred to as the first mode, and a mode of operation when operating as the peripheral device is referred to as the second mode.

[Communication Processing Units 11 and 12]

The communication processing unit 11 performs various communication processes in compliance with USB and OTG according to instructions from the control unit 21. For example, data transmission/reception processing in compliance with the standards of USB, switching the modes of operation in compliance with the standards of OTG, etc. are performed according to instructions from the control unit 21. The communication processing unit 12 has the same function as the communication processing unit 11 in the communication apparatus 102. In other words, according to instructions from the control unit 22, the various communications processes in compliance with USB and OTG are performed.

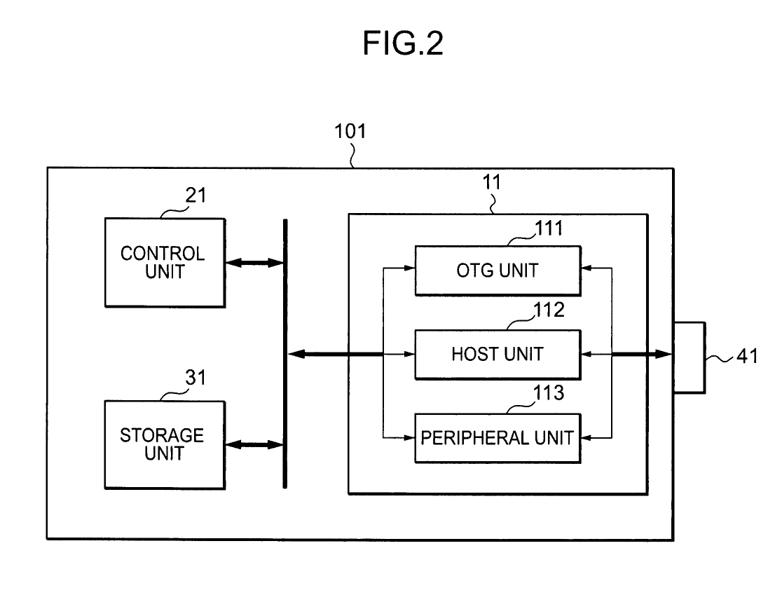

As shown in FIG. 2, for example, the communication processing unit 11 has an OTG unit 111, a host unit 112, and a peripheral unit 113. Although not illustrated in particular, the communication processing unit 12 also has a structure similar to this, for example.

The OTG unit 111 performs the various communication processes defined in OTG. For example, a process of urging re-start of electric current supply to Device A by using SRP (host negotiation protocol), a process of switching the modes of operations (the first mode, the second mode) by using HNP (host negotiation protocol), etc. are performed.

Further, according to the type of the plug terminal (Mini-A plug terminal or Mini-B plug terminal) inserted in the receptacle terminal 41, the OTG unit 111 also performs a process of determining the mode of operation at time of starting, and a process of controlling the supply of a clock signal to the host unit 112 and the peripheral unit 113.

The host unit 112 performs the communication processing when operating in the first mode. In other words, the communication processes as the host device of USB, such as a process of detecting a device connected with a bus (communications cable 50 in the example of FIG. 1), and a process of controlling data transmission over the bus, are performed.

The peripheral unit 113 performs the communication processing when operating in the second mode. In other words, the communication processing is performed under the control of the communication counterpart (the host device) which operates in the first mode as the peripheral device of USB.

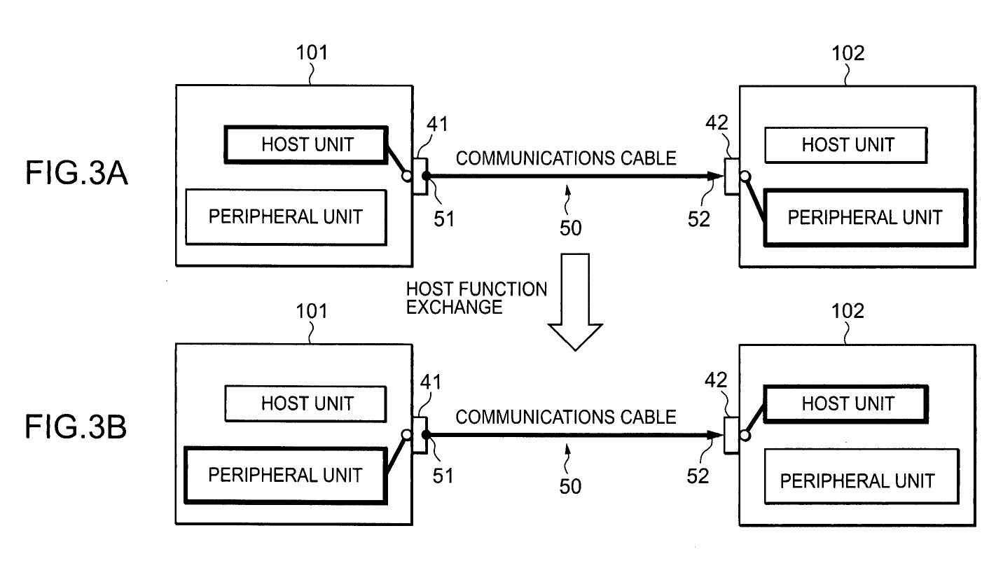

FIG. 3 is a conceptual diagram for explaining the operation of switching the modes of operation in the communication processing units 11 and 12.

In the example of FIG. 1, in the initial status, the communication apparatus 101 operates in the first mode, and the communication apparatus 102 operates in the second mode. At this time, in the communication processing unit 11, as shown in FIG. 3(A), the clock signal is supplied to the host unit 112 under the control of the OTG unit 111, the clock signal supply to the peripheral unit 113 is stopped. On the other hand, in the communication processing unit 12, the clock signal is supplied to the peripheral unit and the clock signal supply to the host unit is stopped.

In this status, if the modes of operation are switched by HNP, as shown in FIG. 3(B), in the communication processing unit 11, the clock signal supply to the host unit 112 is stopped, and the clock signal supply to the peripheral unit 113 is started under the control of the OTG unit 111. On the other hand, in the communication processing unit 12, the clock signal supply to the peripheral unit is stopped and the clock signal supply to the host unit is started. Thus, the communication apparatus 101 operates in the second mode, and the communication apparatus 102 operates in the first mode. In other words, the modes of operation are switched between the communication apparatus 101 and 102, without switching between the plugs 51 and 52 of the communications cable 50.

Although the above is an example when the communication apparatus 101 is Device A, the modes of operation are switched by way of operations similar to the above also when the communication apparatus 102 is Device A.

[Control Units 21, 22]

The control unit 21 performs various processes in connection with control of the overall operation of the communication apparatus 101.

For example, when the communication processing unit 11 operates in the first mode, the control unit 21 performs a process of acquiring various information data required to start communications with the communication counterpart (the peripheral device) which operates in the second mode. In other words, various requests defined in USB are transmitted from the communication processing unit 11 to the peripheral device and a corresponding response from the peripheral device is received in the communication processing unit 11, to thereby acquire information on the peripheral device. After the required information is acquired, the communication processing unit 11 is controlled based on this information, and communicates with the peripheral device.

Further, when the communication processing unit 11 operates in the second mode, the control unit 21 controls the communication processing unit 11 to communicate under the control of the communication counterpart (the host device) which operates in the first mode. In other words, the request from the communication counterpart (the host device) which operates in the first mode is received by the communication processing unit 11, a response, defined by USB, to this request is generated and transmitted from the communication processing unit 11 to the host device.

Furthermore, when the communication processing unit 11 starts in the first mode (i.e. when the communication apparatus 101 is Device A), the control unit 21 controls the communication processing unit 11 so as to acquire information on power consumption of the peripheral device in the first mode and second mode, from the peripheral device which operates in the second mode. In order to acquire this information, enumeration of USB is used as will be described later, for example.

Based on the acquired information on the power consumption of the peripheral device, and the information on the power consumption in the first mode and second mode of the communication apparatus 101 itself, the information being stored in the storage unit 31, it is determined whether or not the power consumption decreases when the mode of operation is switched to that of the peripheral device. When it is determined that the power consumption decreases, the communication processing unit 11 is controlled to switch the mode of operation to that of the peripheral device by HNP.

On the other hand, when the communication processing unit 11 is started with the second mode (i.e. when the communication apparatus 101 is Device B), the control unit 21 causes the information on the power consumption of the communication apparatus 101 itself, the information being stored in the storage unit 31, to be transmitted from the communication processing unit 11 under the control of the host device which operates in the first mode. In the host device, this information on the power consumption is used in the case of performing the above-mentioned determination of whether or not the power consumption decreases by switching the modes of operation.

The control unit 22 has a function similar to that of the control unit 21 in the communication apparatus 102. In other words, processes similar to the above are performed, for example, as various processes in connection with control of the overall operation of the communication apparatus 102.

[Memory Units 31 and 32]

The storage unit 31 stores the data transmitted and received in the communication processing unit 11, and the various information data needed for communication processing.

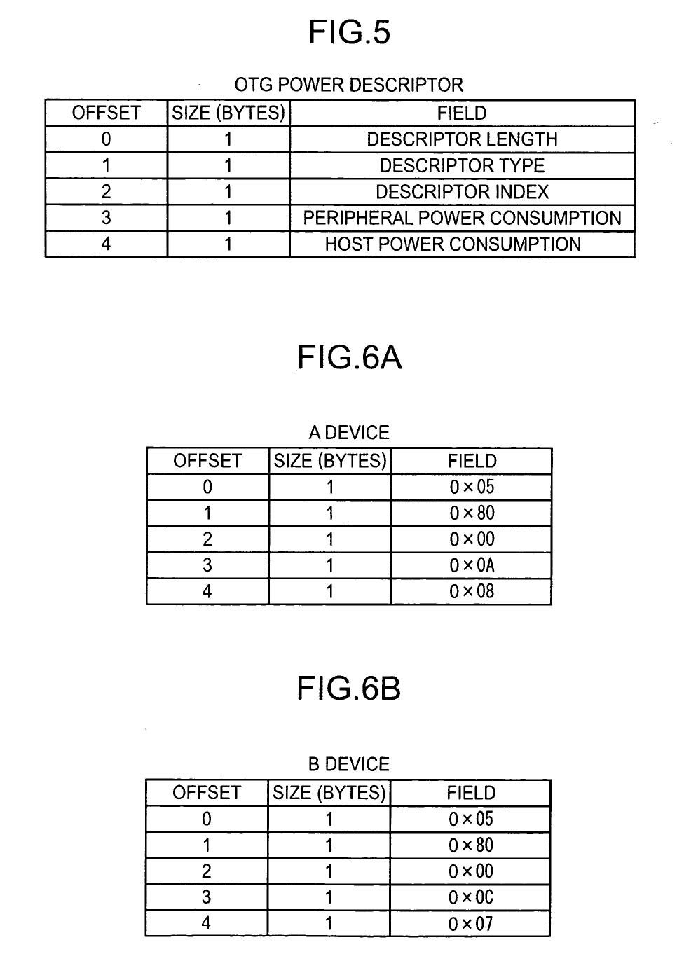

The information stored in the storage unit 31 includes a descriptor, for example. The descriptor is data for the host device to acquire information about the peripheral device, and has a data structure defined in USB. The information on the power consumption in the first mode and the second mode of the communication apparatus 101 are stored in the storage unit 31 as this descriptor, for example. An example of a structure of the descriptor will be described later with reference to FIG. 5.

The storage unit 32 has a function similar to that of the storage unit 31 in the communication apparatus 102. In other words, it stores the data transmitted and received in the communication processing unit 12 and the various data needed for communication processing.

[Receptacle Terminals 41 and 42]

The receptacle terminals 41 and 42 are terminals on the side of the dual-role device defined in OTG, and have a structure allowing either the Mini-A plug terminal or the Mini-B plug terminal to be fixed.

Now, an operation of the communication system as shown in FIG. 1 which has the structure as mentioned above will be described.

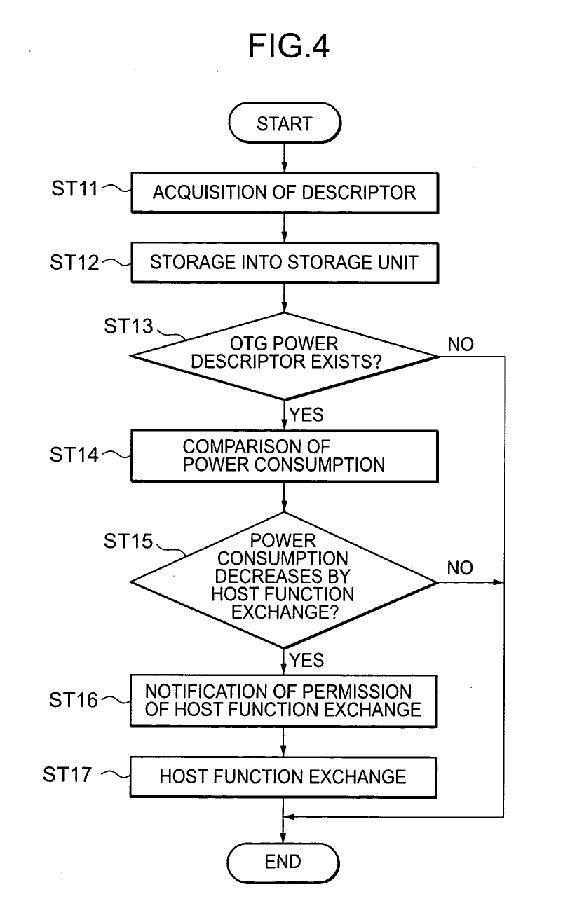

FIG. 4 is a flow chart showing an example of an operation of the communication apparatus 101 which operates as Device A.

The communication processing unit 11 of the communication apparatus 101 detects a type of a plug fixed to the receptacle terminal 41 at time of starting, and notifies it to the control unit 21. Since the receptacle terminal 41 is equipped with the Mini-A plug terminal 51, the control unit 21 starts the control as Device A.

Firstly, the control unit 21 acquires a descriptor from a communication counterpart (communication apparatus 102) in an enumeration process (step ST11). The enumeration is a communication procedure defined by USB, which is performed when the host device and the peripheral device start communications. In the enumeration, the host device collects various information data on the peripheral device, and performs a process of establishing connection. The control unit 21 stores, in the storage unit 31, various types of descriptors acquired by the communication processing unit 11 from the communication apparatus 102 by way of the enumeration (step ST12).

Next, the control unit 21 checks whether there is a predetermined descriptor including the information on the power consumption in the descriptors acquired from the communication counterpart or not (step ST13).

Here, the predetermined descriptor including the information on the power consumption of the communication apparatus is referred to as an OTG Power descriptor.

FIG. 5 is a chart showing an example of a data structure of this OTG Power descriptor.

In FIG. 5, the ‘offset’ column is a column showing a distance (in byte) between a header bit of each data field which constitutes a descriptor, and a header bit of the descriptor.

The ‘size’ column is a column showing a data length (in byte) of each data field of a descriptor. The ‘field’ column is a column showing a content of each data field.

The OTG Power descriptor as shown in FIG. 5 has ‘descriptor length’, ‘descriptor type’, ‘descriptor index’, ‘peripheral power consumption’, and ‘host power consumption’ sequentially from a head as a data field.

A number of bytes of this whole descriptor are stored in ‘descriptor length’.

An identifier for identifying this descriptor is stored in ‘descriptor type’.

An index when there is a plurality of the descriptors is stored in ‘descriptor index’.

A value showing the power consumption when operating in the second mode is stored in ‘peripheral power consumption’.

A value showing the power consumption when operating in the first mode is stored in ‘host power consumption’.

In addition, the values stored in the respective fields of ‘peripheral power consumption’ and ‘host power consumption’ show that the larger the value is the larger the power consumption is.

When such an OTG Power descriptor is acquired from the communication counterpart (communication apparatus 102), the control unit 21 compares the power consumption when switching the modes of operation with that when not switching them (step ST14), based on the acquired OTG Power descriptor of the communication counterpart, and the OTG Power descriptor of the communication apparatus 101 itself stored beforehand in the storage unit 31. In other words, the control unit 21 compares the power consumption when the communication apparatus 101 operates in the first mode and the communication counterpart operates in the second mode, with the power consumption when the communication apparatus 101 operates in the second mode and the communication counterpart operates in the first mode.

From the result of this comparison, it is determined whether or not the power consumption becomes small when the communication counterparts and the modes of operation are switched (step ST15).

For example, the control unit 21 compares the sum of power consumption of both (‘host power consumption’ of Device A+‘peripheral power consumption’ of Device B) when Device A (i.e. communication apparatus 101) operates in the first mode and Device B (i.e. communication apparatus 102) operates in the second mode, with the sum of the power consumption of both (‘peripheral power consumption’ of Device A+‘host power consumption’ of Device B) when Device A operates in the second mode and Device B operates in the first mode. When the latter becomes smaller than the former, it is determined that the power consumption becomes smaller by switching the modes of operation.

FIG. 6 is a first chart showing a particular example of the OTG Power descriptors of Device A and Device B. A symbol ‘0x’ in the ‘field’ column is a symbol showing that a number following this is a hexadecimal number. According to this example, (‘host power consumption’ of Device A+‘peripheral power consumption’ of Device B) is 0x08+0x0C=0x14, and (‘peripheral power consumption’ of Device A+‘host power consumption’ of Device B) is 0x0A+0x07=0x11. In this case, therefore, the control unit 21 determines that the power consumption becomes small by switching the modes of operation.

When it is determined that the power consumption becomes small by switching the modes of operation, the control unit 21 notifies permission of switching the modes of operation to the communication counterpart of Device B (step ST16). Receiving an acknowledgment coming from the communication counterpart in response to this notice, the control unit 21 performs the process of switching the modes of operation by HNP (step ST17).

In addition, when the OTG Power descriptor is not contained in the descriptor acquired from the communication counterpart, or when it is determined that the power consumption does not become small by switching the modes of operation, the control unit 21 does not notify the permission of switching the modes of operation, but maintains the mode of operation, without performing the process of switching the modes of operation by HNP.

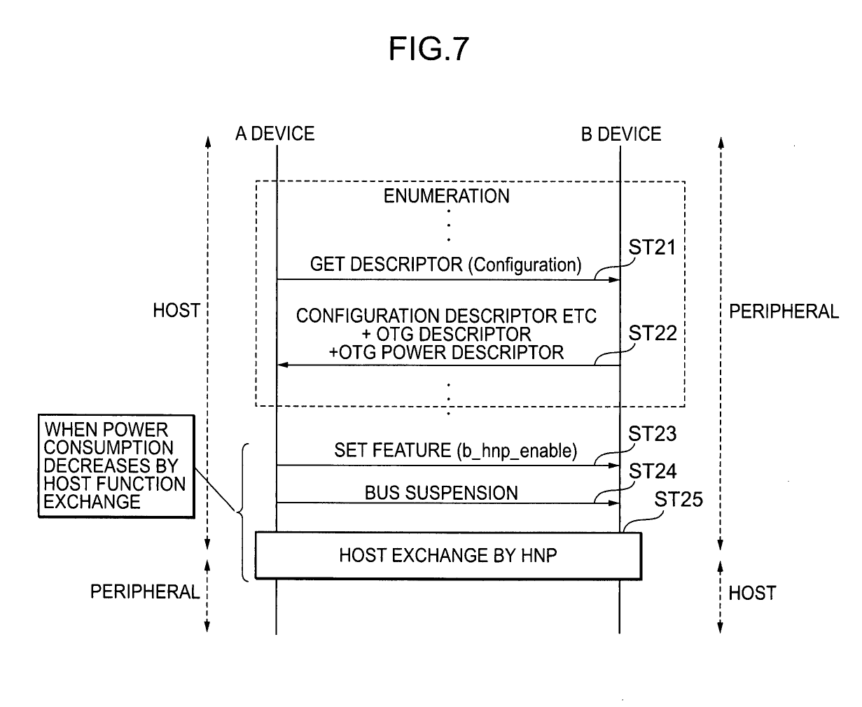

FIG. 7 is a chart for explaining an example of a communication procedure between Device A (communication apparatus 101) and Device B (communication apparatus 102) in the communication system as shown in FIG. 1.

Detecting that Device B is connected to the bus, Device A performs the enumeration as described above. In the enumeration, Device A transmits a standard request ‘Get Descriptor (Configuration)’ defined by USB to Device B (step ST21).

‘Get Descriptor’ is a request for causing a descriptor including information on the peripheral device to be transmitted from the peripheral device to the host device.

‘Get Descriptor (Configuration)’ is a request for specifying a descriptor including information about performance and a function of a device which are especially called ‘configuration descriptor’ as a descriptor required of the peripheral device.

OTG defines that when the dual-role device is asked for ‘configuration descriptor’ by the host device by means of ‘Get Descriptor (Configuration)’, it adds a descriptor called ‘OTG descriptor’ to ‘configuration descriptor’ and transmits it to the host device. ‘OTG descriptor’ is a descriptor including information showing whether or not the dual-role device is in compliance with SRP and HNP.

Therefore, normally, when the dual-role device receives a request of ‘Get Descriptor (Configuration)’ from the host device, it transmits, to Device A, ‘OTG descriptor’ in addition to ‘configuration descriptor’ and a descriptor relevant thereto.

In addition to this ‘OTG descriptor’, the communication apparatuses (101, 102) in accordance with the preferred embodiment further transmit the above-mentioned OTG Power descriptor to Device A (step ST22).

It is an operation in compliance with the standard of USB2.0 that Device B transmits a descriptor peculiar to a class (group of devices which fulfill a specific communication specification) of the device according to the request of ‘Get Descriptor (Configuration)’.

Thus, the OTG Power descriptor is transmitted from Device B to Device A in the method in compliance with the standards of USB2.0 and OTG.

Based on a value of each field of ‘peripheral power consumption’ and ‘host power consumption’ in the OTG Power descriptor acquired from Device B and the OTG Power descriptor of its own, Device A determines whether or not the power consumption becomes small by switching the modes of operation. When it is determined that the power consumption becomes small, Device A transmits ‘Set Feature (b_hnp_enable)’ of a standard request added by OTG to Device B (step ST23). Receiving this request, Device B recognizes that switching the modes of operation is permitted, and returns an acknowledgment to Device A.

Receiving the acknowledgment from Device B, Device A sets the bus as a suspension status, and stops communications (step ST24). When the suspension status of the bus is recognized in Device B, the modes of operation by HNP are switched on both Device A and Device B sides, Device A switches the mode of operation to the second mode, and Device B switches it to the first mode (step ST25).

As described above, when starting with the first mode, by means of the communication apparatuses (101, 102) in accordance with the preferred embodiment, the information (for example, OTG Power descriptor) on the communication performance of the communication counterpart in the first mode and second mode is acquired, under the control of the control units (21, 22), from the communication counterpart operating in the second mode. In the control units (21, 22), based on the acquired OTG Power descriptor of the communication counterpart and the OTG Power descriptor of the communication apparatus of its own stored in the storage units (31, 32), it is determined whether or not the power consumption becomes small when the modes of operation are switched. As a result of this determination, when it is determined that the power consumption becomes small, the permission of the switching the modes of operation by HNP is notified to the communication counterpart according to the instructions from the control units (21, 22), and the switching of the modes of operation by HNP is carried out.

Therefore, since the modes of operation of Device A and Device B are appropriately set up so that the power consumption may become smaller, it may be possible to further reduce the power consumption.

Further, since the modes of operation are switched by the method in compliance with USB2.0 or the standard of OTG, it is possible to apply the preferred embodiment to a device in compliance with these standards easily.

Furthermore, the processing of the preferred embodiment in connection with the switching of the modes of operation as described above is mainly performed by the control units (21, 22), and a computer may realize the control units (21, 22). Therefore, a conventional communication apparatus which controls the whole operation of the communication processing by a computer may be provided with the function in accordance with the preferred embodiment by correcting a computer program, without modifying the hardware.

By the way, in the above-mentioned control units (21, 22), it is determined whether or not to switch the modes of operation, by comparing (‘host power consumption’ of Device A+‘peripheral power consumption’ of Device B) with (‘peripheral power consumption’ of Device A+‘host power consumption’ of Device B). Especially this determination method (hereinafter referred to as the first determination method) is effective when Device B is a ‘bus powered device (bus powered device)’.

The ‘bus powered device’ means a device which receives power supply via the bus from Device A. Since all electric power is supplied from Device A when Device B is the ‘bus powered device’, the total of the above-mentioned power consumption is equivalent to the power consumption of Device A. Therefore, in this case the first determination method is suitable in which a condition where the power consumption of Device A becomes small may be detected.

On the other hand, when Device A and Device B respectively operate with independent power supplies, the power consumption may increase alone even if the power consumption is determined to decrease in the sum of both devices according to the first determination method which sums and compares the power consumption of both devices.

In such a case, the control units (21, 22) of Device A may determine whether or not to switch the modes of operation according to the second determination method, as follows.

In the second determination method, it is determined whether or not the power consumption at time of the first mode is smaller than the power consumption at time of the second mode in the communication counterpart as well as the power consumption at time of the second mode is smaller than the power consumption at time of the first mode in the communication apparatus itself, based on the OTG Power descriptors of both devices. When these conditions are met, the switching of the modes of operation is carried out.

In other words, the control units (21, 22) of Device A determines that the power consumption becomes small, and performs the switching of the modes of operation, when conditions that (‘peripheral power consumption’ of Device B>‘host power consumption’ of Device B) and (‘host power consumption’ of Device A>‘peripheral power consumption’ of Device A) are met. Thus, on condition that the power consumption becomes small in both devices, it is possible to switch the modes of operation.

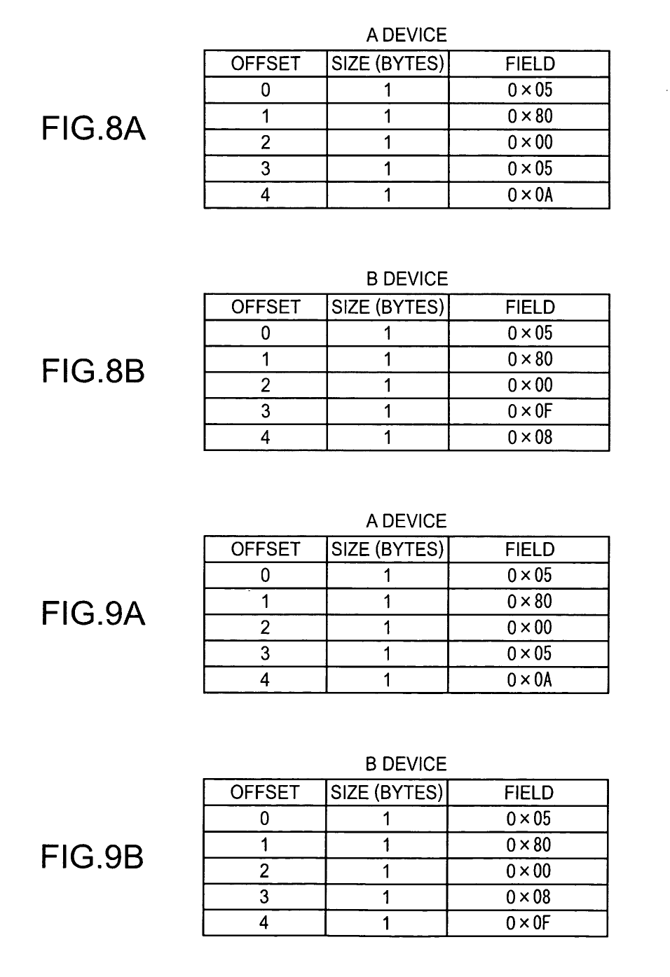

FIG. 8 is a second chart showing a particular example of the OTG Power descriptors of Device A and Device B.

According to this example, since ‘peripheral power consumption’ of Device B is 0x0F and ‘host power consumption’ is 0x08, (‘peripheral power consumption’ of Device B>‘host power consumption’ of >Device B) is achieved. Further, since ‘host power consumption’ of Device A is 0x0A and ‘peripheral power consumption’ is 0x05, (‘host power consumption’ of Device A>‘peripheral power consumption’ of Device A) is achieved. In this case, therefore, the control units (21, 22) of Device A which carry out the determination by the second determination method determine that the power consumption becomes small, and switch the modes of operation.

The first determination method is an effective method when Device B is the ‘bus powered device’, and the second determination method is an effective method when Device A and Device B respectively operate with the independent power supplies.

Therefore, the control units (21, 22) may determine whether or not Device B is the ‘bus powered device’, based on the descriptor etc, and choose a suitable method, either the first determination method or the second determination method, according to the result of the determination.

In other words, the control units (21, 22) may acquire, from the communication counterpart, information indicating whether or not the communication counterpart which operates in the second mode is an apparatus which is supplied with electric power from the bus, and choose either the first determination method or the second determination method according to the acquired information.

Thus, it is possible to determine the suitable power consumption, considering also a power supply system of Device B.

Furthermore, as the third determination method, the control units (21, 22) of Device A may determine the power consumption, based only on the OTG Power descriptor of the communication apparatus itself, without considering information on Device B.

In other words, when the conditions that (‘host power consumption’ of Device A>‘peripheral power consumption’ of Device A) are met, the control units (21, 22) of Device A may determine that the power consumption becomes small, and switch the modes of operation.

FIG. 9 is a third chart showing a particular example of the OTG Power descriptors of Device A and Device B.

According to this example, since ‘peripheral power consumption’ of Device B is 0x08 and ‘host power consumption’ is 0x0F, (‘peripheral power consumption’ of Device B>‘host power consumption’ of Device B) is not achieved. However, since ‘host power consumption’ of Device A is 0x0A and ‘peripheral power consumption’ is 0x05, (‘host power consumption’ of Device A>‘peripheral power consumption’ of Device A) is achieved. In this case, therefore, the control units (21, 22) of Device A which carry out the determination by the third determination method switch the modes of operation.

The third determination method is especially effective when Device A is a device which operates with a battery power supply.

For example, suppose that Device A has a battery power supply unit and further a battery residual power detecting unit which detects a battery residual power. When the battery residual power detected by this battery residual power detecting unit is lower than a predetermined threshold value (i.e. when there is little battery residual power), the control units (21, 22) determine the power consumption by the third determination method, whereby faults, such as a communication error due to the fall in battery voltage, may be avoided.

Further, when the battery residual power exceeds the predetermined threshold value, the power consumption may be determined by the first determination method or the second determination method as described above, for example.

In addition, in USB2.0, three communication speeds called low speed, full speed, and high speed are defined in increasing order. In general, the higher the communication speed becomes, the larger there is a tendency for instantaneous power consumption to become. Then, the control units (21, 22) of Device A may also consider the communication speed together with the mode of operation, and determine the power consumption.

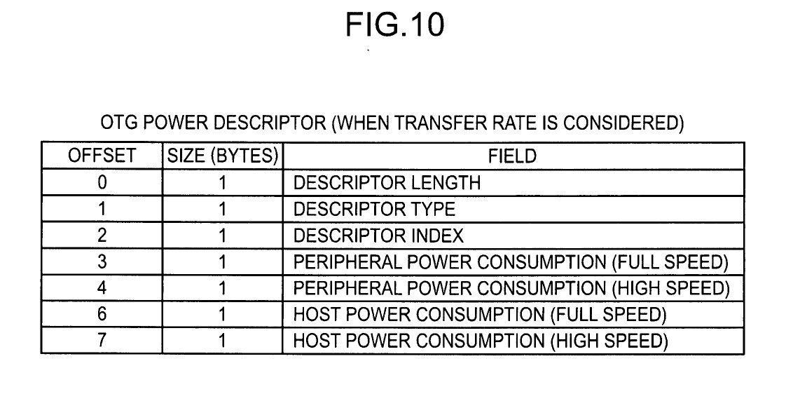

FIG. 10 is a chart showing an example of a data structure of the OTG Power descriptor including information on the communication speed.

The OTG Power descriptor as shown in FIG. 10 has fields of ‘peripheral power consumption’ and ‘host power consumption’ for each of the case where the communication speed is full speed and the case where it is high speed.

In other words, it has the information on four types of power consumption equivalent to the number of combination of two modes (the first mode, the second mode) of operation and two communication speeds (full speed, high speed).

If such an OTG Power descriptor is used, the control units (21, 22) of Device A may select the information on the power consumption corresponding to the communication speed which is to be set up between A and Device Bs, and determine the power consumption by the first via third determination methods as already described, based on the selected information.

Thus, by determining the power consumption, considering the communication speed, the power consumption may be reduced more appropriately.

### Second Preferred Embodiment

Next, a second preferred embodiment of the present invention will be described.

In the second preferred embodiment, the switching of the modes of operation is performed so that the communication speed may be increased.

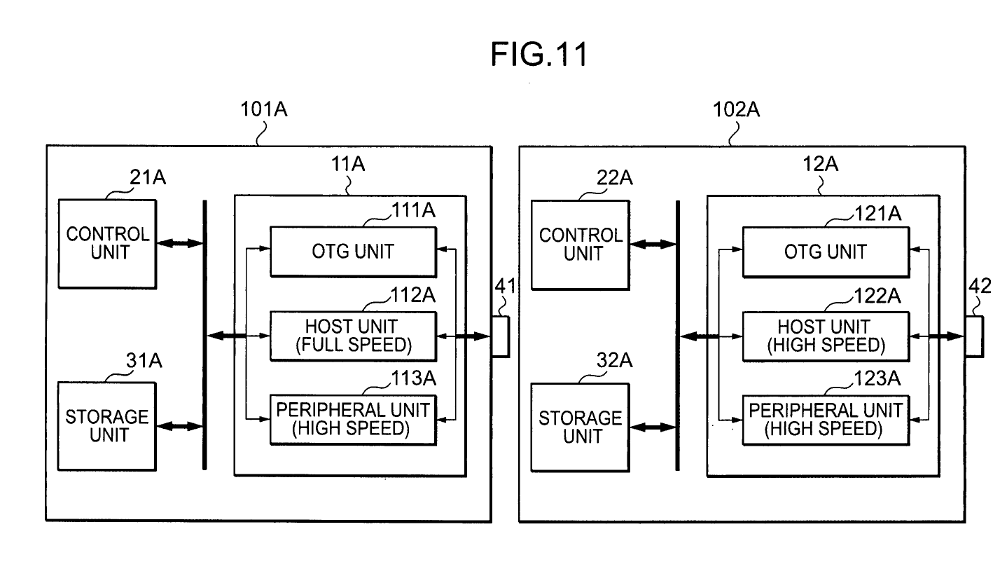

FIG. 11 is a diagram showing an example of a structure of the communication apparatuses 101A and 102A in accordance with the second preferred embodiment. The same reference signs in FIG. 1 and FIG. 11 indicate the same elements.

The communication apparatus 101A has a communication processing unit 11A, a control unit 21A, a storage unit 31A, and the receptacle terminal 41.

The communication apparatus 102A has a communication processing unit 12A, a control unit 22A, a storage unit 32A, and the receptacle terminal 42.

[Communication Processing Units 11A and 12A]

In the example of FIG. 11, the communication processing unit 11A has an OTG unit 111A, a host unit 112A, and a peripheral unit 113A.

The communications processing unit 12A has an OTG unit 121A, a host unit 122A, and a peripheral unit 123A.

The OTG units 111A and 121A, the host units 112A and 122A, and the peripheral units 113A and 123A respectively have the functions similar to the OTG unit 111, the host unit 112, and the peripheral unit 113 as already described.

However, in the example of FIG. 11, the communication speeds of the host units 112A and 122A and the peripheral units 113A and 123A are each provided. In other words, the host unit 112A may communicate at full speed; the peripheral unit 113A at high speed; the host unit 122A at high speed; the peripheral unit 123A at high speed.

[Control Units 21A and 22A]

Similar to the control units 21 and 22 as already described, the control unit 21A performs various processes in connection with control of the overall operation of the communication apparatus 101A.

Further, when the communication processing unit 11A is started with the first mode (i.e. when communication apparatus 101A is Device A), the control unit 21A controls the communication processing unit 11A in such a way as to acquire information on the communication speed of the peripheral device in the first mode, from the peripheral device which operates in the second mode. Then, based on the acquired information on the communication speed of the peripheral device, and the information on the communication speed in the first mode of the communication apparatus 101A itself, the information being stored in the storage unit 31A, it is determined whether or not the communication speed increases, when the mode of operation is switched to that of the peripheral device. When it is determined that the communication speed increases, the communication processing unit 11A is controlled to switch the mode of operation by HNP to that of the peripheral device.

On the other hand, when the communication processing unit 11A is started with the second mode (i.e. when the communication apparatus 101A is Device B), the control unit 21A causes the information on the communication speed of the communication apparatus 101 itself, the information being stored in the storage unit 31A, to be transmitted from the communication processing unit 11A under the control of the host device which operates in the first mode. In the host device, this information on the communication speed is used in the case of determining whether or not the communication speed is increased by switching the modes of operation as described above.

In the communication apparatus 102A, the control unit 22A has a function similar to that of the above-mentioned control unit 21A.

[Memory Units 31A and 32A]

Similar to the storage units 31 and 32 as already described, the storage unit 31A stores the data transmitted and received in the communication processing unit 11A, and various information data (descriptor etc.) needed for communication processing.

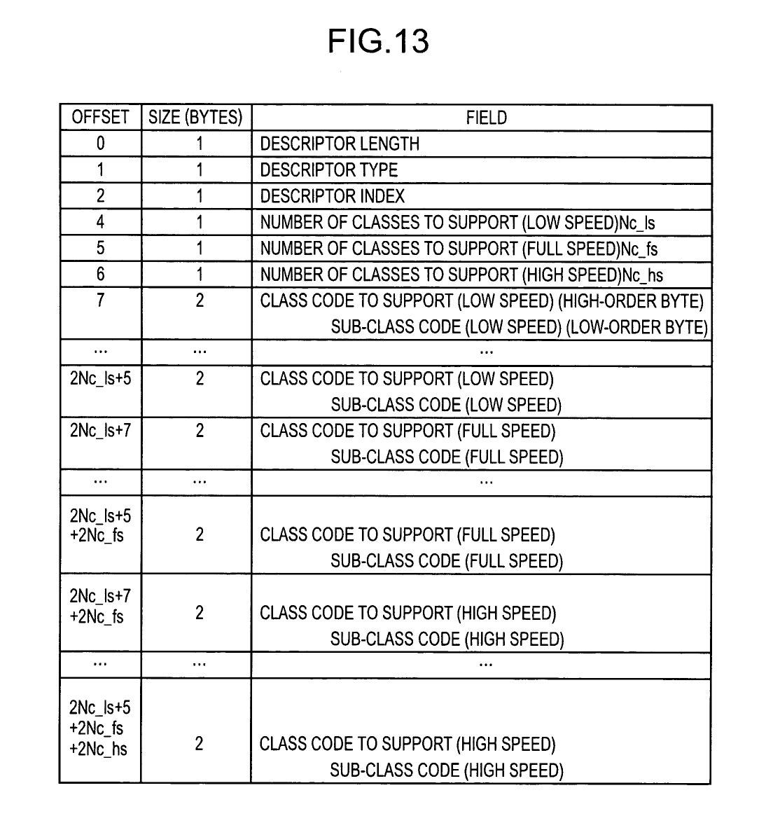

Further, a descriptor including the information on the communication speed in the first mode of the communication apparatus 101A is stored in the descriptor stored in the storage unit 31A. An example of a structure of this descriptor will be described later with reference to FIG. 13.

In the communication apparatus 102A, the storage unit 32A has a function similar to that of the storage unit 31A as described above.

Now, an operation of the communication apparatus as shown in FIG. 11 having the above-mentioned structure will be described. Here, as shown in FIG. 1 by way of example, it is assumed that the communication apparatus 101A and communication apparatus 102A are connected with the communications cable 50, the communication apparatus 101A is started as Device A and the communication apparatus 102A is started as Device B.

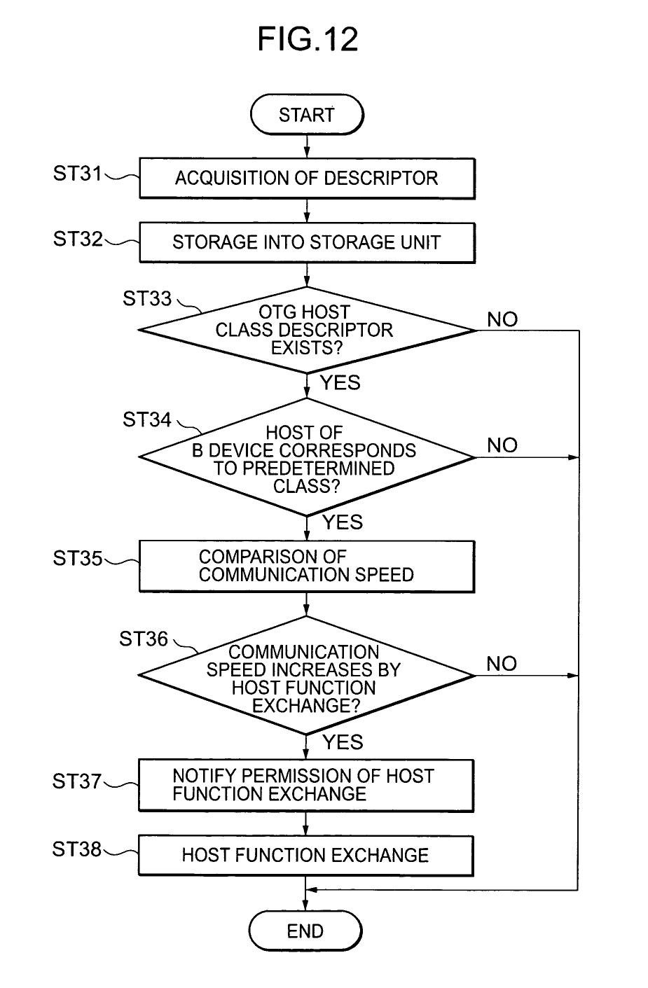

FIG. 12 is a flow chart showing an example of an operation of the communication apparatus 101A which operates as Device A.

Firstly, in an enumeration process, the control unit 21A acquires a descriptor from the communication counterpart (communication apparatus 102A) (step ST31), and stores this in the storage unit 31A (step ST32).

Next, the control unit 21A checks whether there is a predetermined descriptor including the information on the communication speed in the descriptor acquired from the communication counterpart (step ST33).

Here, the predetermined descriptor including the information on the communication speed of the communication apparatus is referred to as an OTG Host Class descriptor.

FIG. 13 is a chart showing an example of a data structure of this OTG Host Class descriptor.

The OTG Host Class descriptor as shown in FIG. 13 stores information on all the classes corresponding to the case where the communication apparatus operates in the first mode, and its communication speed.

As shown in FIG. 13, the data field is provided with ‘descriptor length’, ‘descriptor type’, ‘descriptor index’, ‘number of classes to support (low speed) Nc_ls’, ‘number of classes to support (full speed) Nc_fs’, and ‘numberof classes to support (high speed) Nc_hs’ sequentially from the head, and further provided with ‘class code to support/sub-class code’ in the order of low speed, full speed, and high speed.

The meaning of each field of ‘descriptor length’, ‘descriptor type’, and ‘descriptor index’ is the same as that of the above-mentioned OTG Power descriptor.

The number of classes with which communications may be carried out at each communication speed is stored in ‘the number of classes to support’. For example, the number of the classes with which communications may be carried out at low speed is stored in ‘number of classes to support (low speed) Nc_ls’.

A class code and a sub-class code corresponding to the case where the communication apparatus operates in the first mode are stored in ‘class code to support/sub-class code’. The class code and the sub-class code are peculiar codes provided for each device having a similar communication specification in USB.

When such an OTG Host Class descriptor is acquired from the communication counterpart (communication apparatus 102A), the control unit 21A checks ‘class code to support/sub-class code’ of the acquired OTG Host Class descriptor of the communication counterpart, and checks whether or not a code of the class to be used for communication is included in it (step ST34).

When the code of the class to be used is included, the control unit 21A compares the communication speed when switching the modes of operation with that when not switching them, based on the OTG Host Class descriptor acquired from the communication counterpart and communication speed information at time of the second mode as well as the OTG Host Class descriptor of the communication apparatus 101A itself, which is stored beforehand in the storage unit 31A, and communication speed information at time of the second mode (step ST35). In other words, in the class to be used for communication, the control unit 21A compares the communication speed when the communication apparatus 101A operates in the first mode and the communication counterpart operates in the second mode, with the communication speed when the communication apparatus 101A operates in the second mode and the communication counterpart operates in the first mode.

Then, as a result of this comparison, when the mode of operation is switched to that of the communication counterpart, it is determined whether or not the communication speed increases (step ST36).

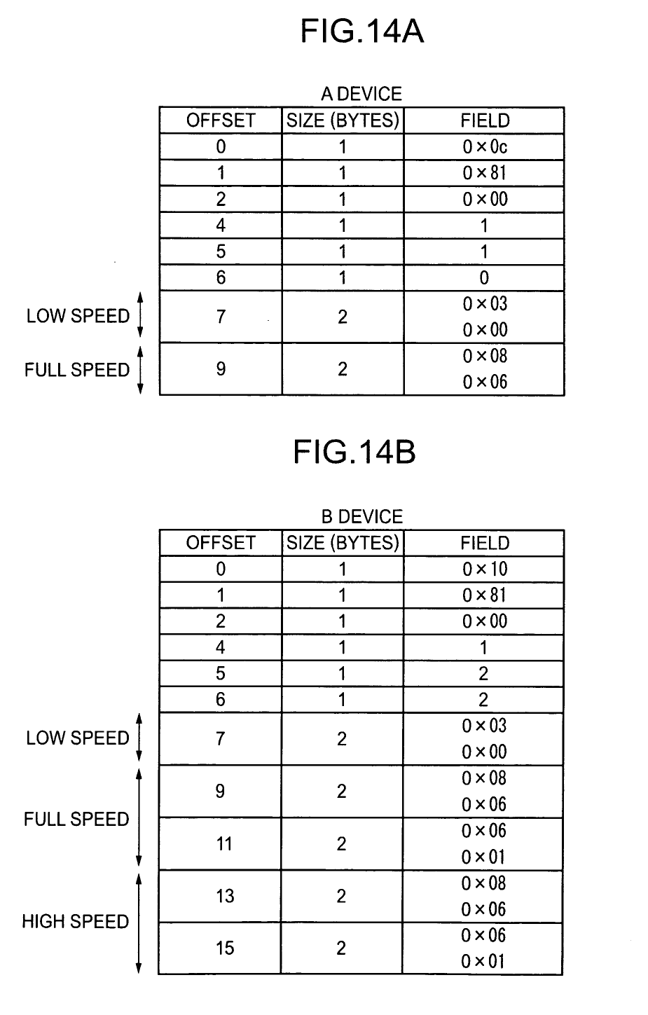

FIG. 14 is a chart showing a particular example of the OTG Host Class descriptors of Device A and Device B.

According to this chart, for example, when communicating by means of a class in which a class code is expressed as 0x08, and a sub-class code is expressed as 0x06 (this code is assigned to a mass storage class in USB), and when Device A is a host, it is possible to communicate at full speed at the maximum. On the other hand, when Device B is the host, it may be seen that the communications may be achieved at high speed at the maximum. In this case, therefore, the control unit 21A determines that the communication speed increases when the mode of operation is switched to that of the communication counterpart.

When it is determined that the communication speed increases by switching the modes of operation, the control unit 21A notifies the permission of switching the modes of operation to the communication counterpart of Device B (step ST37). If the acknowledgment comes from the communication counterpart with respect to this notice, the control unit 21A performs the switching of the modes of operation by HNP (step ST38).

In addition, the control unit 21A maintains the mode of operation, without switching the modes of operation by HNP, when the OTG Host Class descriptor is not included in the descriptor acquired from the communication counterpart, or when the code of the class to be used is not included in the OTG Host Class descriptor (i.e. when the information showing that it is possible to communicate according to a predetermined communication specification is not included in the OTG Host Class descriptor, in case the communication counterpart operates in the first mode), alternatively when it is determined that the communication speed is not increased by switching the modes of operation.

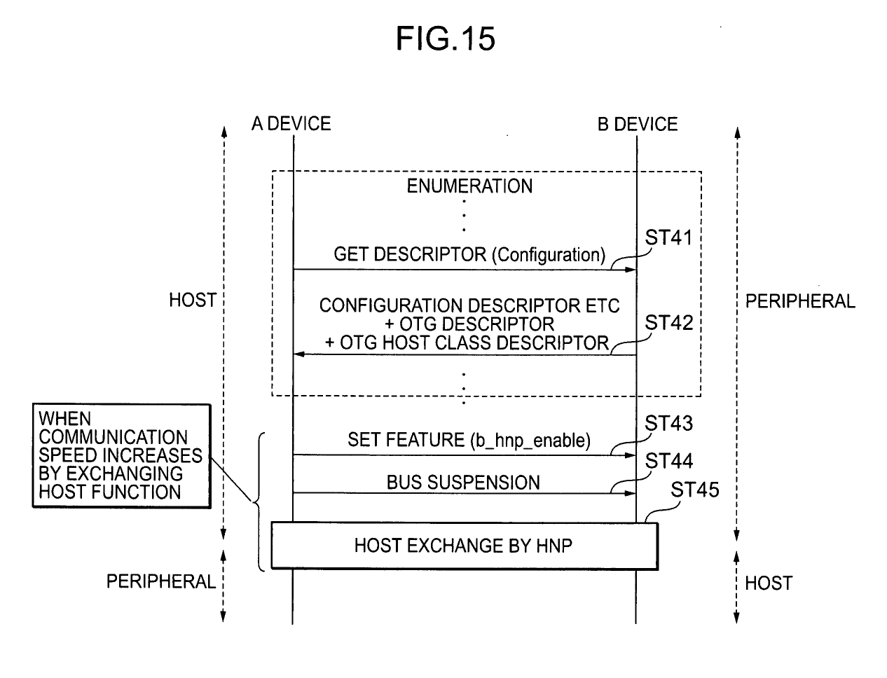

FIG. 15 is a chart for explaining an example of a communication procedure between Device A (the communication apparatus 101A) and Device B (communication apparatus 102B).

Detecting that Device B is connected to the bus, Device A carries out the above-mentioned enumeration. In the enumeration, Device A transmits the standard request ‘Get Descriptor (Configuration)’ of USB to Device B (step ST41).

Receiving this request, Device B transmits ‘configuration descriptor’, and a descriptor relevant thereto, as well as ‘OTG descriptor’ to Device A.

In addition to this ‘OTG descriptor’, the communication apparatuses (101A, 102A) in accordance with the preferred embodiment further transmit the above-mentioned OTG Host Class descriptor to Device A (step ST42).

The OTG Host Class descriptor is transmitted from Device A to Device B in the method in compliance with the standards of USB2.0 and OTG.

Based on the information on the communication speed in the acquired OTG Host Class descriptor and the OTG Host Class descriptor of its own, Device A determines whether or not the communication speed is increased by switching the modes of operation. When it is determined that the communication speed increases, ‘Set Feature (b_hnp_enable)’ of the standard request added by OTG is transmitted to Device B (step ST43). Receiving this request, Device B recognizes that the switching of the modes of operation is permitted, and returns an acknowledgment to Device A.

Receiving the acknowledgment from Device B, Device A sets the bus as the suspension status, and stops communications (step ST44). When the suspension status of the bus is recognized in Device B, the switching of the modes of operation by HNP is performed on both Device A and Device B sides, Device A switches the mode of operation to the second mode, and Device B switches it to the first mode (step ST45).

As described above, when starting with the first mode, by means of the communication apparatuses (101A, 102A) in accordance with the preferred embodiment, the information (for example, OTG Host Class descriptor) on the communication performance of the communication counterpart in the first mode is acquired from the communication counterpart which operates in the second mode under the control of the control units (21A, 22A). In the control units (21A, 22A), based on the acquired OTG Host Class descriptor of the communication counterpart, and the OTG Host Class descriptor of its own communication apparatus stored in the storage units (31A, 32A), it is determined whether or not the communication speed increases when the modes of operation are switched. When it is determined that the communication speed is increased as a result of this determination, the permission of switching the modes of operation by HNP is notified to the communication counterpart according to instructions from the control units (21A, 22A), and the switching of the modes of operation by HNP is performed.

Therefore, the modes of operation of Device A and Device B are appropriately set up so that the communication speed may increase, thus further improvement in the speed of communication speed may be attained.

Further, as with the communication apparatuses 101,102 as already described, the modes of operation may be switched by the method in compliance with the standards of USB2.0 or OTG, and the control units (21A, 22A) may be realized by a computer, which provides similar effects.

In addition, in the above-mentioned preferred embodiments, the OTG Host Class descriptor including information on the speed in the first mode is used as the information related to the speeds of Device A and Device B. Although it is possible to determine the communication speed by comparing only the communication speeds in the first mode when the communication speeds at time of the second mode in the class to be used are both high speed in two communication apparatuses, it is necessary to consider the communication speed at time of the second mode, when the communication speed at time of the second mode contains the communication apparatus which does not have high speed.

In this case, based on the information on the communication speed when the communication counterpart operates in each of the first mode and the second mode, the information being acquired from the communication counterpart, and the information on the communication speed when the communication apparatus itself operates in each of the first mode and the second mode, the information being stored in the storage units (31A, 32A), the control units (21A, 22A) of Device A may determine whether or not the communication speed increases when the mode of operation is switched to that of the communication counterpart. According to the result of this determination, the modes of operation may be switched. In this case, the information on the communication speed acquired from the communication counterpart may be a data in a descriptor format, or otherwise may be a signal transmitted from Device B to Device A according to the voltage gap in a signal line of the bus.

In the above, although several preferred embodiments in accordance with the present invention are described, the present invention is not limited to these preferred embodiments, and so includes further various variations.

Therefore, the present invention should not be construed as to be limited to such examples, so that various modifications, variations, combinations, sub combinations as well as different applications thereof are possible for the present invention without departing from the scope of this invention.

In addition to the above, various embodiments are possible for the structure of the communication apparatus, the operation at time of HNP, the contents of the descriptor, etc., for example.

Further, the flow charts and communication procedures as described above are also examples only, and various embodiments are available based on differences in the power consumption or the communication speed according to the mode of operation.

In USB, since the host device has initiatives of use of various functions and data transmission, it may be necessary to determine whether or not the modes of operation are switched, considering a user's intention. Then, in the case of switching the modes of operation, the user's approval may be obtained via a predetermined user interface apparatus.

In other words, when the conditions for switching the modes of operation as described above are met, the control unit notifies the user of a request for a check of whether or not to switch the modes of operation, via the user interface apparatus. When a response of the permission with respect to the notice of the check is inputted into the user interface apparatus, the switching of the modes of operation may be carried out.

Further, in the case of this notice of the check, information on the communication performance when the modes of operation are switched or when not switched (information on the power consumption, or the communication speed, etc.) may be displayed on the user interface apparatus, which may be used for the determination when the user determines whether or not to switch the modes of operation, for example.

The preferred embodiments as described above show the examples in which the power consumption and the communication speed are improved by switching the modes of operation. Other than these, it may be determined whether or not the communication performance is improved when switching the modes of operation, based on the information on the various communication performances which change due to the switching of the modes of operation.

As for each structure of the communication apparatus in each preferred embodiment as described above, at least part of the structure may be realized by a computer and software based on a computer program, or it may be realized by a combination of software and hardware, or the whole structure may be realized by hardware.

Although examples of the communication apparatus which performs communications in compliance with USB and OTG are provided in the preferred embodiments as described above, the present invention is not limited thereto. For example, the present invention may also be applied to a communication apparatus in compliance with other various communication protocols in which the mode of operation when communications are carried out via the bus may be switched from the first mode of controlling data transmission over the bus, to the second mode of communication under the control of the communication counterpart which operates in the first mode.

1. A communication system including two communication apparatuses which communicate via a bus, wherein when one communication apparatus operates in a first mode of controlling data transmission over said bus, the other communication apparatus operates in a second mode of performing communications under the control of said one communication apparatus, and modes of operation of said two communication apparatuses are switched according to a communication protocol, said communication apparatus comprising:
a storage unit for storing information related to a communication performance when said communication apparatus itself operates in each of said first mode and said second mode; and
a control unit for switching said operation modes when it is determined that communication performance is improved by determining whether or not said communication performance is improved when said modes of operation are switched, based on acquired information on communication performance of a communication counterpart and information, stored in said storage unit, on communication performance of the communication apparatus itself; wherein:
when starting with said second mode, said information on communication performance stored in said storage unit is outputted to said bus under the control of the communication counterpart which operates in said first mode of operation; and
when starting with said first mode, said information on communication performance is acquired via said bus from the communication counterpart which operates in said second mode of operation.

2. A communication apparatus in which modes of operation when performing communications via a bus may be switched between a first mode of controlling data transmission over said bus, and a second mode of performing communications under control of a communication counterpart which operates in said first mode, said communication apparatus comprising:
storage unit for storing information related to a predetermined communication performance when the communication apparatus itself operates in each of said first mode and said second mode; and
control unit for switching said operation modes according to a communication protocol when it is determined that communication performance is improved by determining whether or not said communication performance is improved when said mode of operation with the communication counterpart are switched, based on acquired information on communication performance of said communication counterpart and information, stored in said storage unit, on communication performance of the communication apparatus itself; wherein:
when starting with said first mode, information on said communication performance of said communication counterpart in said first mode and said second mode is acquired from said communication counterpart which operates in said second mode of operation.

3. The communication apparatus according to claim 2, wherein when starting with said second mode, said control unit outputs the information on said communication performance stored in said storage unit to said bus, under control of the communication counterpart which operates in said first mode of operation.

4. The communication apparatus according to claim 2, wherein said storage unit stores one or both of information on communication speed and information on power consumption as the information related to said communication performance.

5. The communication apparatus according to claim 4, wherein said control unit determines whether or not a sum of power consumption of the communication counterpart and power consumption of the communication apparatus itself decreases when the mode of operation is switched with the communication counterpart, and switches said modes of operation according a result of said determination, based on said information on power consumption at time of said first mode and said second mode, acquired from the communication counterpart, and said information on power consumption at time of said first mode and said second mode, stored in said storage unit.

6. The communication apparatus according to claim 4, wherein said control unit determines whether or not said power consumption at time of said first mode is smaller than said power consumption at time of said second mode, and whether or not said power consumption at time of said second mode for the communication apparatus itself is smaller than said power consumption at time of said first mode, and switches said modes of operation according a result of said determination, based on said information on power consumption at time of said first mode and said second mode, acquired from the communication counterpart, and said information on power consumption at time of said first mode and said second mode, stored in said storage unit.

7. The communication apparatus according to claim 4 further comprising:
a battery power supply unit; and
a battery residual power detecting unit for detecting battery residual power of said battery power supply unit;
wherein:
said control unit switches said modes of operation, when the battery residual power detected in said battery residual power detecting unit is lower than a threshold value and said power consumption at time of said second mode for the communication apparatus itself is lower than said power consumption at time of said first mode.

8. The communication apparatus according to claim 4, wherein said control unit determines whether or not communication speed increases when the mode of operation is switched with said communication counterpart, and switches said modes of operation according to a result of said determination, based on information on the communication speed acquired from the communication counterpart, when said communication counterpart operates in said first mode, and information on communication speed stored in said storage unit, when the communication apparatus itself operates in said first mode.

9. The communication apparatus according to claim 8, wherein said control unit determines whether or not communication speed increases when the mode of operation is switched with said communication counterpart, and switches said modes of operation according to a result of said determination, based on information on the communication speed, acquired from the communication counterpart, when the communication counterpart operates in each of said first mode and said second mode, and information on the communication speed, stored in said storage unit, when the communication apparatus itself operates in each of said first mode and said second mode.

10. The communication apparatus according to claim 8, wherein said control unit does not switch said modes of operation, if information acquired from the communication counterpart operating in said first mode does not include information showing that communications according to a communication specification is possible.

11. The communication apparatus according to claim 2 further comprising a receptacle terminal to which a first plug terminal and a second plug terminal may be connected; wherein:
said control unit is started with said first mode when connected from said receptacle terminal to said bus via said first plug, and is started with said second mode when connected from said receptacle terminal to said bus via said second plug.

12. A communication method in which when one of two communication apparatuses communicating via a bus operates in a first mode of controlling data transmission over said bus, the other communication apparatus operates in a second mode of performing communications under the control of said one communication apparatus, and the modes of operation of said two communication apparatuses may be switched according to a communication protocol, said method comprising:
a first step of starting a first communication apparatus with said first mode, and starting a second communication apparatus with said second mode;
a second step of transmitting from said second communication apparatus to said first communication apparatus via said bus, information related to a communication performance in a case where said second communication apparatus operates in each of said first mode and said second mode;
a third step of causing said first communication apparatus to determine whether or not said communication performance is improved when said modes of operation are switched, based on information on communication performance acquired from said second communication apparatus, and information on said communication performance of its own in said first mode and said second mode; and
a fourth step of causing said first communication apparatus to switch said modes of operation when it is determined in said third step that said communication performance is improved.

13. A computer-executable program for controlling a communication apparatus for switching a mode of operation at time of performing communications via a bus, between a first mode of controlling data transmission over said bus, and a second mode of performing communications under control of a communication counterpart which operates in said first mode, said program including the steps of a method comprising:
a first step of acquiring information on a communication performance of said communication counterpart in said first mode and said second mode, from the communication counterpart operating in said second mode of operation, when starting with said first mode;
a second step of determining whether or not said communication performance is improved when the mode of operation is switched with said communication counterpart, based on the information on the communication performance of the communication counterpart, acquired in said first step, and the information on said communication performance of the communication apparatus itself in said first mode and said second mode; and
a third step of switching said modes of operation according to a communication protocol, when it is determined in said second step that said communication performance is improved.
